(19) United States
(12) Patent Application Publication
(10) Pub. No.: US 2019/0079195 A1
(43) Pub. Date: Mar. 14, 2019

(54) METHOD AND/OR SYSTEM FOR PROCESSING SATELLITE POSITIONING SYSTEM SIGNALS AT A MOBILE DEVICE

(71) Applicant: QUALCOMM Incorporated, San Diego, CA (US)

(72) Inventors: Harisrinivas Chandrasekar, San Diego, CA (US); Prabhu Kandasamy, San Diego, CA (US); Naveen Kumar V. Bonda, San Diego, CA (US)

(21) Appl. No.: 15/703,775

(22) Filed: Sep. 13, 2017

(51) Int. Cl. G01S 19/06; G01S 19/35; G01S 19/07

(52) U.S. Cl. CPC G01S 19/06; G01S 19/07; G01S 19/35

(57) ABSTRACT

Methods and systems are disclosed for processing satellite positioning system (SPS) signals at a mobile device. In an embodiment, SPS signals may be acquired at multiple instances over a first duration while the mobile device is camped on one or more signals transmitted by a first access device. The mobile device may then determine a second duration of time to acquire a subsequent SPS signal based, at least in part, on the acquired SPS signals, representations of system time in signals received from the first access device contemporaneously with acquisition of the SPS signals and an indication of stationarity of the mobile device during the first duration.

### BACKGROUND

### Field

Subject matter disclosed herein relates to estimation of a location of a mobile device.

### Information

The location of a mobile device, such as a cellular telephone, may be useful or essential to a number of applications including emergency calls, navigation, direction finding, asset tracking and Internet service. The location of a mobile device may be estimated based on information gathered from various systems. The Global Positioning System (GPS), and other like satellite positioning systems (SPSs), have enabled navigation receivers on mobile devices to process signals from transmitters aboard space vehicles (“SPS signals”) to obtain location estimates and/or navigation solutions. For example, by processing SPS signals to obtain pseudorange measurements to four or more measuring transmitters at known locations, a mobile device may estimate its location using well known techniques.

### SUMMARY

Briefly, one particular implementation is directed to a method at a mobile device comprising: acquiring satellite positioning system (SPS) signals at multiple instances over a first duration while the mobile device is camped on one or more signals transmitted by a first access device; determining one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and determining a second duration of time to acquire a subsequent SPS signal based, at least in part, on the one or more parameters indicative of the error in the clock signal maintained at the mobile device.

Another particular implementation is directed to a mobile device comprising: a first receiver to process satellite positioning system (SPS) signals; a second receiver to process signals transmitted in a communication network; and one or more processors to: acquire SPS signals received at the first receiver at multiple instances over a first duration while the second receiver is camped on one or more signals transmitted by a first access device; determine one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and determine a second duration of time to acquire a subsequent SPS signal received at the second receiver based, at least in part, on the one or more parameters indicative of the error in the clock signal maintained at the mobile device.

Another particular implementation is directed to a storage medium comprising computer readable instructions stored thereon which are executable by one or more processors of a mobile device to: acquire satellite positioning system (SPS) signals received at the mobile device at multiple instances over a first duration while the mobile device is camped on one or more signals transmitted by a first access device; determine one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and determine a second duration of time to acquire a subsequent SPS signal based, at least in part, on the one or more parameters indicative of the error in the clock signal maintained at the mobile device.

Another particular implementation is directed to a mobile device comprising: means for acquiring satellite positioning system (SPS) signals at multiple instances over a first duration while the mobile device is camped on one or more signals transmitted by a first access device; means for determining one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and means for determining a second duration of time to acquire a subsequent SPS signal based, at least in part, on the one or more parameters indicative of the error in the clock signal maintained at the mobile device.

It should be understood that the aforementioned implementations are merely example implementations, and that claimed subject matter is not necessarily limited to any particular aspect of these example implementations.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a system diagram illustrating certain features of a system containing a mobile device, in accordance with an implementation;

FIG. 2 is a flow diagram of a process according to an embodiment;

FIG. 3 is a system diagram illustrating certain features of a system containing mobile devices, in accordance with an alternative implementation;

FIG. 4 is a schematic block diagram of a mobile device, in accordance with an example implementation;

FIG. 5 is a schematic block diagram of an example computing platform in accordance with an implementation; and

FIG. 6. is a schematic block diagram of an example computing platform in accordance with an implementation.

Reference is made in the following detailed description to accompanying drawings, which form a part hereof, wherein like numerals may designate like parts throughout that are identical, similar and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like mean that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. However, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

As pointed out above, a mobile device may obtain an estimate of its position based, at least in part, on pseudorange measurements obtained from processing signals transmitted by multiple transmitters in a satellite positioning system (SPS). For example, a mobile device may tune an SPS receiver to acquire an SPS signal transmitted from a transmitters to obtain measurements such as an arrival of symbols for detection of a code phase. If the mobile device has a rough indication of its location (e.g., an estimated location with an associated uncertainty) and an accurate estimate of time (e.g., relative to SPS time or a system time), the mobile device may configure its receiver to acquire an SPS signal over a limited duration so as to limit time that power is applied to a receiver circuit for acquisition of the SPS signal to thereby limit battery consumption.

To obtain an estimate of SPS time for determining a duration to search for an SPS signal, a mobile device may internally maintain a clock state to propagate/estimate a system time that is synchronized with SPS time. In particular implementations, the mobile device may comprise receivers to facilitate communication with terrestrial access devices in a communication network. The mobile device may update and/or synchronize an estimate of system time maintained by its internal clock based, at least in part, on indications of time observed in signals received from terrestrial access devices (e.g., eNode B devices, WLAN access points, femto cell transceivers, etc.). Errors in observed indications of time in signals transmitted from terrestrial access devices may arise, for example, from a frequency error of an oscillator used for propagating a clock state maintained at the terrestrial access device. The larger an error in observed indications of time in signals transmitted from a terrestrial access device, the larger an uncertainty in system time (e.g., SPS time) and the longer a duration of time for search of an SPS signal may be determined.

Different terrestrial access devices may have varying capabilities to maintain system time at a particular accuracy or within a particular uncertainty. Current WWAN based GPS time maintenance (e.g., at an eNode B device) may assume a clock error rate set forth by standards. As such, a mobile device searching to acquire a GPS signal based on an estimate of system time determined from observation of a terrestrial signal from a WWAN may determine a search window based, at least in part, on such a clock error rate defined by standards. Base stations in the field, however, may maintain a clock state with clock error rates much larger or smaller than specified according to standards. For instance, a Wide Area base station may have a clock error rate of 10 ppb instead of 50 ppb (which may be set forth by a standard). If the accurate error rate was known, the clock uncertainty propagation may be reduced by 80%, allowing for use of a much smaller search window for searching an SPS signal.

According to an embodiment, a mobile device may estimate an error in an indication of a system time obtained from observation of signals from a terrestrial access device. Based, at least in part, on the estimate of the error, the mobile device may determine a duration for searching an SPS signal for obtaining a position fix. According to an embodiment, a mobile device may obtain observations of signals transmitted from an access device while “camped on” the access device for service (e.g., voice or data service). While camped on the access device, the mobile device may acquire an SPS signal providing an accurate indication of a system time. Here, signals transmitted from the access device and received at the mobile device may be “time stamped” or “time tagged” with an SPS time determined from contemporaneous acquisition of an SPS signal. By obtaining multiple time stamped observations of signals transmitted from an access device and received at the mobile device, the mobile device may estimate an error in an oscillation frequency of a clock maintained at the access device.

Estimates of a frequency error (of an oscillating signal used to propagate a clock state) obtained from acquisition of signals transmitted by an access device may be affected by the presence of multipath in that a mobile device may receive multipath components of a signal transmitted by the access device in addition to line-of-sight components. In particular implementations, effects of multipath on accuracy of estimates of an error in oscillating frequency obtained at a mobile device from observation of signals transmitted by an access device may be ameliorated or reduced if the mobile device is stationary while observing the signals. As such, utility of such estimates of system may be determined based, at least in part, on a degree of stationarity of the mobile device while observing the signals transmitted by the access device.

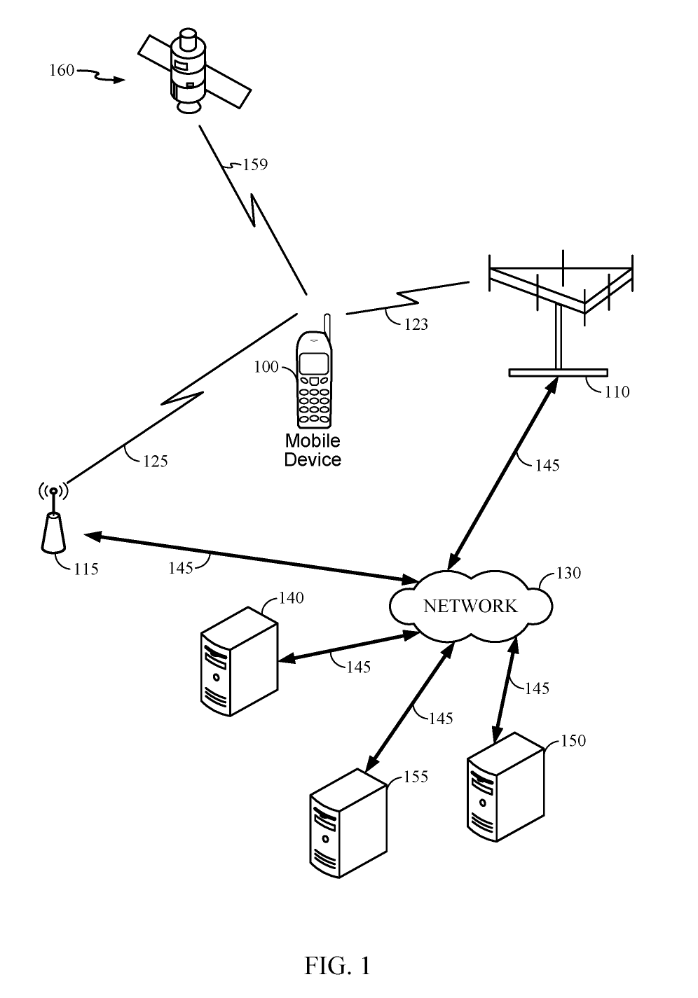

FIG. 1 is a system diagram illustrating certain features of a system containing a mobile device (MD) 100, in accordance with an implementation. An MD 100 may receive or acquire satellite positioning system (SPS) signals 159 from one or more SPS satellites 160. In some implementations, SPS satellites 160 comprising transmitters may be from one global navigation satellite system (GNSS), such as the GPS or Galileo satellite systems. In other implementations, the SPS Satellites may be from multiple GNSS such as, but not limited to, GPS, Galileo, Glonass, or Beidou (Compass) satellite systems. In other implementations, SPS satellites may be from any one several regional navigation satellite systems (RNSS′) such as, for example, WAAS, EGNOS, QZSS, just to name a few examples.

In addition, the MD 100 may transmit radio signals to, and/or receive radio signals from, a wireless communication network. In one example, MD 100 may communicate with a cellular communication network by transmitting wireless signals to, or receiving wireless signals from, a base station transceiver 110 over a wireless communication link 123. Similarly, MD 100 may transmit wireless signals to, or receiving wireless signals from a local transceiver 115 over a wireless communication link 125.

In a particular implementation, local transceiver 115 may be configured to communicate with MD 100 at a shorter range over wireless communication link 123 than at a range enabled by base station transceiver 110 over wireless communication link 123. For example, local transceiver 115 may be positioned in an indoor environment. Local transceiver 115 may provide access to a wireless local area network (WLAN, e.g., IEEE Std. 802.11 network) or wireless personal area network (WPAN, e.g., Bluetooth network). In another example implementation, local transceiver 115 may comprise a femtocell transceiver capable of facilitating communication on link 125 according to a cellular communication protocol. Of course, it should be understood that these are merely examples of networks that may communicate with an MD over a wireless link, and/or claimed subject matter is not limited in this respect.

In a particular implementation, base station transceiver 110 and/or local transceiver 115 may communicate with servers 140, 150 and/or 155 over a network 130 through links 145. Here, network 130 may comprise any combination of wired or wireless links. In a particular implementation, network 130 may comprise Internet Protocol (IP) infrastructure capable of facilitating communication between MD 100 and servers 140, 150 or 155 through local transceiver 115 or base station transceiver 110. In another implementation, network 130 may comprising cellular communication network infrastructure such as, for example, a base station controller or master switching center to facilitate mobile cellular communication with MD 100.

In particular implementations, and/or as discussed below, MD 100 may have circuitry and/or processing resources capable of computing a position fix or estimated location of MD 100. For example, MD 100 may compute a position fix based, at least in part, on pseudorange measurements to four or more SPS satellites 160. Here, MD 100 may compute such pseudorange measurements based, at least in part, on pseudonoise code phase detections in signals 159 acquired from four or more SPS satellites 160. In particular implementations, MD 100 may receive from server 140, 150 or 155 positioning assistance data to aid in the acquisition of signals 159 transmitted by SPS satellites 160 including, for example, almanac, ephemeris data, Doppler search windows, just to name a few examples.

As pointed out above, MD 100 may estimate a duration of time to search for and/or acquire signals 159 based, at least in part, on an estimate of system time maintained at MD 100. Receiving signals transmitted from a terrestrial access device such as local transceiver 115 or base station transceiver 110, for example, MD 100 may update an internally maintained clock state based on a time of arrival of symbols detected in the received signals. Such symbols in the received signals may be synchronized according to a state of a clock maintained at the terrestrial access device. As pointed out above, MD 100 may model an extent of drift associated with the clock maintained at the terrestrial access device based, at least in part, on observations of a signal 159 obtained contemporaneously with observations of indications of system time in the signal transmitted by the terrestrial access device (e.g., signals transmitted by local transceiver 115 or base station transceiver 110 as part of wireless communication links 123 or 125). If the mobile device uses this signal transmitted by the terrestrial access device to estimate system for search for or acquisition of a subsequent SPS signal in the future, this modeled drift may be used for determining a duration of time to search for the subsequent SPS signal.

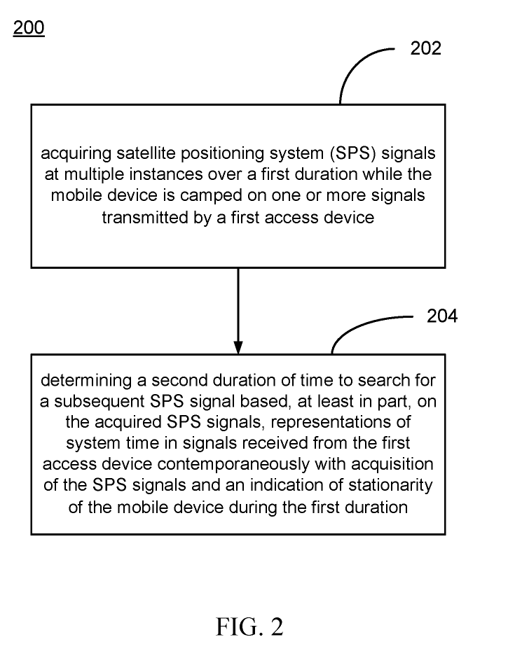

FIG. 2 is a flow diagram of a process for determining a duration of time to search for or to acquire an SPS signal according to an embodiment. In one implementation, actions at blocks 202, 204 and 206 may be performed by a mobile device such as MD 100. Block 202 may comprise acquisition by a mobile device of one or more SPS signals from the same or different SPS transmitter (e.g., the same or different space vehicle (SV) in a GNSS) over a first duration of time while the mobile device is camped on one or more signals transmitted by a first access device. In this context, “acquisition” of an SPS signal by a mobile device, as referred to herein, means detecting one or more attributes of the SPS signal including at least an indication of time (e.g., SPS time). For example, an SPS receiver at a mobile device acquiring a GPS signal may determine an indication of time by decoding a data channel of the GPS signal indicating a GPS week, time of week (milliseconds). A more accurate indication of time may be obtained from acquisition of GPS signals transmitted by multiple space vehicles. An “access device” as referred to in block 202 may comprise any device capable of establishing a communication link with a mobile device according to a communication protocol that enables the mobile device to receive one or more services from a communication network. For example, a mobile device may comprise a WLAN access point, Bluetooth® enabled device, eNode B base station, femtocell transceiver or picocell transceiver, just to provide a few examples.

Also, “camped on” one or more signals, as referred to herein, means a particular state of a device in which the device substantially continuously receives and monitors, processes, detects, decodes, demodulates or interprets one or more signals transmitted by a source. In a particular implementation, a mobile device may camp on one or more signals transmitted by an access device by detecting symbols or parameters indicative of a system time according to a clock state maintained by the access device. Here, a base station configured as an LTE eNB may continuously transmit a system frame number (SFN) as part of a master information block (MIB) on a physical broadcast channel (PBC). Determination of the SFN transmitted from the eNB may enable a camped on mobile device to synchronize its system time with a system time maintained by the eNB. According to an embodiment, at block 202 a mobile device may process one or more signals transmitted by the first access device to obtain indications of a system time according to a clock state maintained at the first access device. Contemporaneously with obtaining the indications of time according to the clock state maintained at the first access device, the mobile device may process acquired SPS signals to obtain indications of a system time (e.g., “SPS time”) at particular instances over a duration. Here, the mobile device may further “time tag” or “time stamp” indications of system time obtained by processing the one or more signals transmitted by the first access device with indications of system time obtained from processing the acquired SPS signals.

As pointed out above, following an initial acquisition of one or more initial SPS signals (e.g., at block 202), a mobile device may attempt to acquire a subsequent SPS signal to, for example, obtain an updated position fix. For example, mobile device 100 may acquire an initial SPS signal 159 over a first duration followed by acquisition a subsequent SPS signal 159 over a second duration sometime later to obtain an updated position fix. As discussed below, an uncertainty in time as maintained by mobile device 100 during acquisition of the subsequent SPS signal may be based, at least in part, on an accuracy in measurement of a system time from acquisition of the initial SPS signal 159 during the first duration. For example, errors in a clock signal generated by mobile device to propagate a system time may introduce errors in a system time during acquisition of the subsequent SPS signal 159. Block 204 may comprise determining one or more parameters indicative of an error in a clock signal maintained at a mobile device based, at least in part, on indications of system time obtained at block 202 by processing the one or more signals transmitted by the first access device time tagged or time stamped with indications of system time obtained from processing the acquired SPS signals. Block 206 may then determine a second duration of time to acquire the subsequent SPS signal based, at least in part, on the one or more parameters determined at block 204.

According to an embodiment, an access device may maintain a clock state for tracking a system time by propagating the clock state in response to or as controlled by oscillation of a local oscillator at an oscillation frequency. Errors in the oscillation frequency of the local oscillator (e.g., arising from temperature of the local oscillator or manufacturing tolerances) may introduce errors in a clock state propagated to track a system time. For example, errors in an oscillation frequency of a local oscillator controlling or propagating a state of a clock may impart “drift” in the tracked system time.

According to an embodiment, an error in a frequency of an oscillating signal to advance a clock state maintained at an access device may be estimated access device based, at least in part, on multiple observations of signals transmitted by the access device and time tagged with SPS time. In a particular example, a frequency error FreqError of a clock maintained by an eNode B device in an WWAN may be estimated according to expression (1) based on two time stamped observations of a signal transmitted by the eNode B device as follows:

$$FreqError ( in ppb ) = \vert \frac{WWAN @ T 2 - WWAN @ T 1}{GPS @ T 2 - GPS @ T 1} - 1 \vert \times {10}^{9} + Delta \qquad ( 1 )$$

where:
WWAN@T1 is an observation of time based on acquisition of a signal transmitted by an access device (e.g., eNode B device serving a cell or a WLAN access point) at an instance T1;
WWAN@T2 is an observation of time based on acquisition of a signal transmitted by the access device at an instance T2;
GPS@T1 is an observation of SPS time (e.g., GPS time) based on acquisition of an SPS signal transmitted by an SPS transmitter at instance T1; and
GPS@T2 is an observation of SPS time (e.g., GPS time) based on acquisition of an SPS signal transmitted by an SPS transmitter at instance T2.

In one particular implementation, Delta may comprise an adjustment to a computation of FreqError based on one more factors such as, for example, on expected hardware and calibration specific errors and a degree of stationarity or movement of between instances T1 and T2. Expression (1) is directed to an example embodiment in which an error in frequency of an oscillating signal at an eNode B device based on observations of system time obtained from acquisition of a GPS signal. In other embodiments, expression (1) may be applied to estimating an error in frequency of an oscillating signal at any access device based on observations of system time obtained from acquisition of an SPS signal other than a GPS signal. In one embodiment, an estimated frequency error computed according to expression (1) may be computed for multiple time-tagged pairs to determine an averaged number. Alternatively, a maximum value may be used to provide a conservative estimate. For subsequent attempts to acquire an SPS signal, this estimate in frequency error rate may be used to propagate WWAN clock and accurately estimate SPS time.

As indicated above, expression (1) above may be directed to a determination of frequency error FreqError based, at least in part, on a degree of stationarity of a mobile device while observing an SPS signal at times T1 and T2. As may be observed, a value for GPS@T2-GPS@T1 in expression (1) may be affected by movement of the observing mobile device relative to a transmitter of the observed SPS signal between times T1 and T2, which would affect a value for estimate FreqError computed according to expression (1). According to an embodiment, block 204 may determine a value computed for estimate FreqError based, at least in part, on a degree of stationarity of a mobile device observing the SPS signal between times T1 and T2. In an example implementation, block 204 may determine a value for Delta based on a degree of stationarity according to expression (2) as follows:

Delta=FreqError_{HC}+FreqError_{M}, (2)

where:
FreqError_{HC} is a component of frequency error attributed to expected hardware and calibration specific errors; and
FreqError_{M} is a component of frequency error attributed to movement of the mobile device between instances T1 and T2.

In one example implementation, GPS time for a future attempt to acquire a GPS signal (at a future instance T3) may be estimated according to expression (3) as follows:

GPS time @T3=GPS time @T2+(WWAN@T3−WWAN@T2) (3)

where:
GPS time@T3 is an estimate of SPS time (e.g., GPS time) at an instance T3; and
WWAN@T3 is an observation of time based on acquisition of a signal transmitted by the access device at an instance T3.

An uncertainty in GPS time at time T3 (e.g., for use in determining a second duration for searching or to acquire a GPS signal at block 206) may be computed according to expression (4) as follows:

GPS unc@T3=GPS unc@T2+(WWAN@T3−WWAN@T2)×FreqError(in ppb) (4)

where:
GPS unc@T2 is an uncertainty in SPS time (e.g., GPS time) at instance T2;
GPS unc@T3 is an uncertainty in SPS time at instance T3; and
FreqError(in ppb) is an estimated error in frequency computed according to expression (1).

As pointed out above, an SPS receiver may determine GPS time from one or more acquired GPS signals based, at least in part, on a decoded data channel. Determination of GPS time based on acquisition of a single GPS signal may comprise a determination of GPS time with a set uncertainty (e.g., GPS unc @T2 or GPS unc @T3). Determination of GPS time based on acquisition of multiple GPS signal transmitted from multiple different space vehicles, however, may reduce this uncertainty.

Expressions (1) through (4) above are directed to a specific example of computing an uncertainty in a system time determined according to a state of a clock maintained at an access device based, at least in part, on observations of time obtained from acquisition of GPS signals at block 202 and contemporaneous observations of the system time as maintained by a WWAN access device (e.g., eNode B device serving a cell). It should be understood that this is merely an example implementation and that other techniques may be implemented without deviating from claims subject matter. For example, a frequency error determined at expression (1) may comprise a frequency error of an oscillator propagating a clock state maintained at an access device in a WLAN or Bluetooth® system. Additionally, a frequency error determined at expression (1) may be determined based on observations of SPS signals other than GPS signals without deviating from claimed subject matter. Likewise, uncertainty in time computed at expression (4) may be computed for an uncertainty in time for any SPS other than GPS.

Based, at least in part, on uncertainty in time and position, a mobile device receiver may determine an approximate time window for searching to acquire SPS signals. In one implementation, for example, if SPS time uncertainty is less than 50.0 μsec, an SPS receiver may perform a scan to acquire SPS signals within a 200 ms window.

In particular scenarios, a presence of multipath while a mobile device is camped on one or more signals transmitted by a first access device at block 202 may affect an ability of the mobile device to accurately estimate an error in a frequency of an oscillating signal based on observations of tine based on the one or more signals (e.g., WWAN@T1 and WWAN@T2 at expression (1)). For example, as pointed out above, observation of time based at a receiver on observation of a multipath component of a signal transmitted by the first access device may introduce a lag as compared with an observation of time at the receiver based on observation of a line-of-sight component of the signal transmitted by the first access device. Multipath may arise in a WWAN, for example, in the presence of obstructions such as walls or buildings between a mobile device and an access device such as an eNB device. Changes in location of the mobile device from instance T1 to instance T2 may affect a multipath profile of the mobile device. This may affect WWAN timing detected by the mobile device at instance T2. According to an embodiment, a mobile device may be capable of ameliorating effects of multipath on computation of frequency error at expression (1) by being stationary between observations obtained at instances T1 and T2.

According to an embodiment, block 204 may selectively apply observations obtained at block 202 in determining one more parameters indicative of an error of time to search for a subsequent SPS signal based, at least in part, on an indication of stationarity of a mobile device over first duration for obtaining the observations in block 202. For example, an indication of stationarity suggesting substantial movement of the mobile device over the first duration may likewise suggest that a computation of frequency error at expression (1) (and likewise a computation of GPS time uncertainty at expression (4)) is unreliable because of a likelihood of unmitigated multipath corruption.

According to an embodiment, an indication of stationarity may comprise one or more signals that are indicative of or responsive to movement of a mobile device. Such an indication of stationarity may comprise a numerical value for use in determining or computing a value for FreqError_{M} as a component of Delta incorporated in a computation of FreqError according to expression (1). In an example implementation, a mobile device may be capable of receiving and processing ambient signals (e.g., light or radio frequency (RF) signals) from stationary sources such as broadcast signals or signals from In one example, a mobile device may evaluate its stationarity based, at least in part, on detected changes in ambient received radio frequency (RF) signals (e.g., increases or decreases in received power). In another example, a mobile device may comprise one or more inertial sensors (e.g., accelerometers, gyroscopes, gravitometers, magnetometers, etc.) that are capable of generating one or more signals responsive to movement (e.g., rotation, linear acceleration, etc.). In an example implementation, signals from one or more sources (e.g., received ambient signals or signals generated by inertial sensors) may be processed and combined to generate one or more values indicative of a degree of stationarity of the mobile device over a duration. In an implementation, block 204 may apply such one or more values indicative of a degree of stationarity to one or more threshold values to determine whether a second duration of time to search for a subsequent SPS signal is to be based on observations obtained at block 202. In an example implementation, a mobile device may determine that a large frequency FreqError exceeding a threshold value indicates that an estimate of time at instance T3 according to expression (3) to be too unreliable for use in determining a search window for acquisition of an SPS signal at instance T3. For example, if a mobile device is travelling in an automobile at 60 miles per hour between instances T1 and T2, a value for FreqError_{M} may be determined to be very large based on a detection of a change in Doppler detected in SPS signals received between instances T1 and T2 while the automobile is moving.

In another embodiment, a mobile device may maintain or update a computed estimate in a rate of growth in an error in frequency based, at least in part, on parameters indicative of an the error in frequency determined at block 204. Using this updated estimate in the growth rate of the error, the mobile device may propagate the estimate in error to a future instance subsequent to instance T3. The mobile device may determine a duration of time to acquire an SPS signal at this future instance based, at least in part, on an application of the propagated estimate of the error in frequency to expression (4).

According to an embodiment, a mobile device may estimate errors in frequency of multiple different oscillating signals generated at multiple different access devices to advance clock states maintained at the multiple different access devices. For example, as shown in FIG. 1, mobile device 100 may camp on signals from either local transceiver 115 or base station transceiver 110 (e.g., simultaneously or at different times). In one scenario, mobile device 100 may receive signals from local transceiver 115 and base station transceiver 110 leading up to acquisition of an SPS signal wherein signals from local transceiver 115 and base station transceiver each have indications of a system time. As such, mobile device 100 may determine a duration of time to search for or to acquire an SPS signal based on a first indication of time obtained from signals transmitted by local transceiver 115 or based on a second indication of time obtained from signals transmitted by base station transceiver 110. Here, mobile device 100 may be capable of estimating errors in frequency of oscillating signals generated at both local transceiver 115 and base station transceiver 110 (e.g., according to expression (1) as discussed above).

In an implementation, for determining a duration to search for or to acquire an SPS signal, mobile device 100 may select a system time according to a signal from an access device generating an oscillating signal (for advancing a clock state to represent a system time) having a smallest associated estimated error. For example, mobile device 100 may compute a first estimated error in frequency according to expression (1) for an oscillating signal maintained at local transceiver 115, and compute a second estimated error in frequency according to expression (1) for an oscillating signal maintained at base station transceiver 110. For computing a duration to search for or to acquire an SPS signal, mobile device 100 may select an indication of time based on signals transmitted from local transceiver 115 if the second estimated error is larger than the first estimated error. Likewise, mobile device 100 may select an indication of time based on signals transmitted from base station transceiver 110 if the first estimated error is larger than the second estimated error.

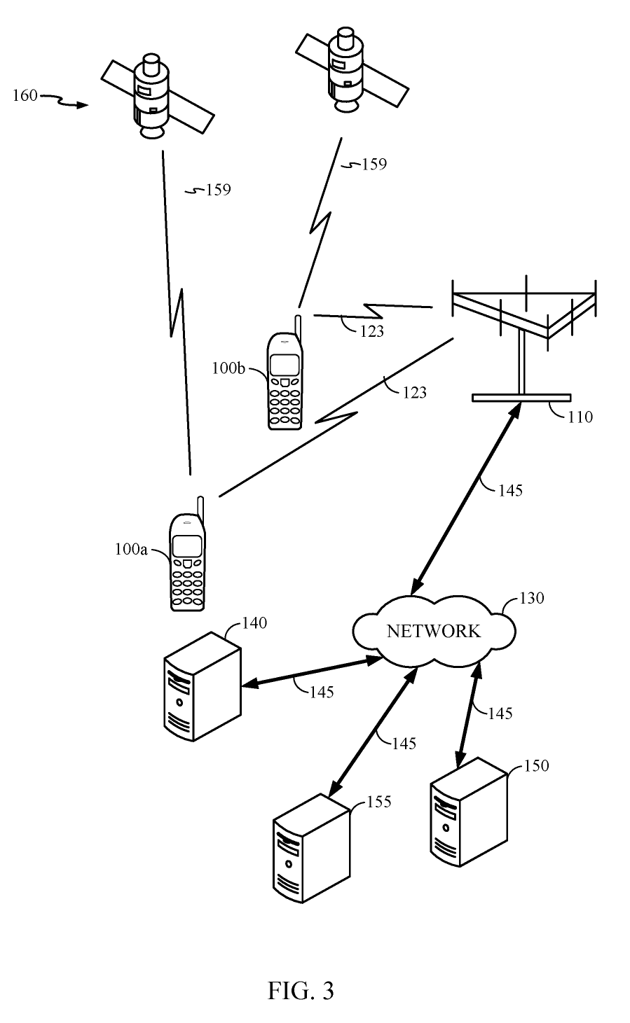

Embodiments discussed above are directed to, among other things, a determination of a duration for searching for or acquiring an SPS signal based, at least in part, on of an estimate of an error in a frequency of an oscillating signal used to propagate a clock state maintained at an access device. In particular exemplary implementations discussed above, a mobile device may estimate an error in frequency of the oscillating signal based on observations obtained by the mobile device of signals transmitted by the access device. In other implementations, as illustrated in FIG. 3, an estimate of an error in a frequency of such an oscillating signal may be based on observations of signals obtained by multiple mobile devices. For example, mobile devices 100ₐ and 100_{b} may both obtain observations of signals in wireless communication links 123 transmitted by base station 110 contemporaneously with observations of SPS signals 159 to estimate an error in frequency of an oscillating signal (e.g., according to expression (1) above). Estimates of the error in frequency may be provided to a server (e.g., server 140, 150 or 155) to be combined by averaging, weighting or smoothing, etc., to compute a combined or “crowdsourced” estimate of the error in frequency of the oscillating signal. The combined estimate of the error in frequency may be subsequently provided to mobile devices 100ₐ or 100_{b} as positioning assistance data to be used in computing an uncertainty in SPS time as set forth in expression (3). In addition to computing a combined estimate of the error in frequency of the oscillating signal, a server may compute a rate of growth in the error in frequency of the oscillating signal which may be similarly provided to mobile devices 100ₐ or 100_{b} as positioning assistance data to be used in computing an uncertainty in SPS time as set forth in expression (3). As pointed out above, mobile device 100ₐ or 100_{b} may use this estimate in the growth rate of the error to propagate the estimate in error to a future instance. The mobile device may determine a duration of time to acquire an SPS signal at this future instance based, at least in part, on an application of the propagated estimate of the error in frequency to expression (4).

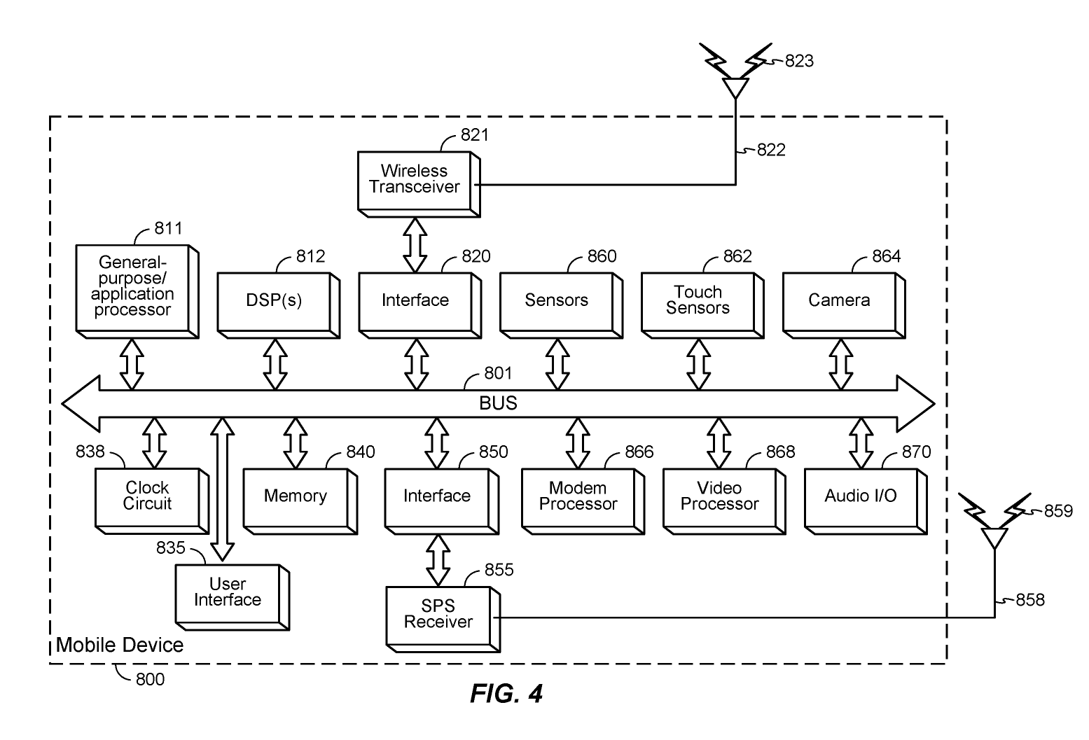

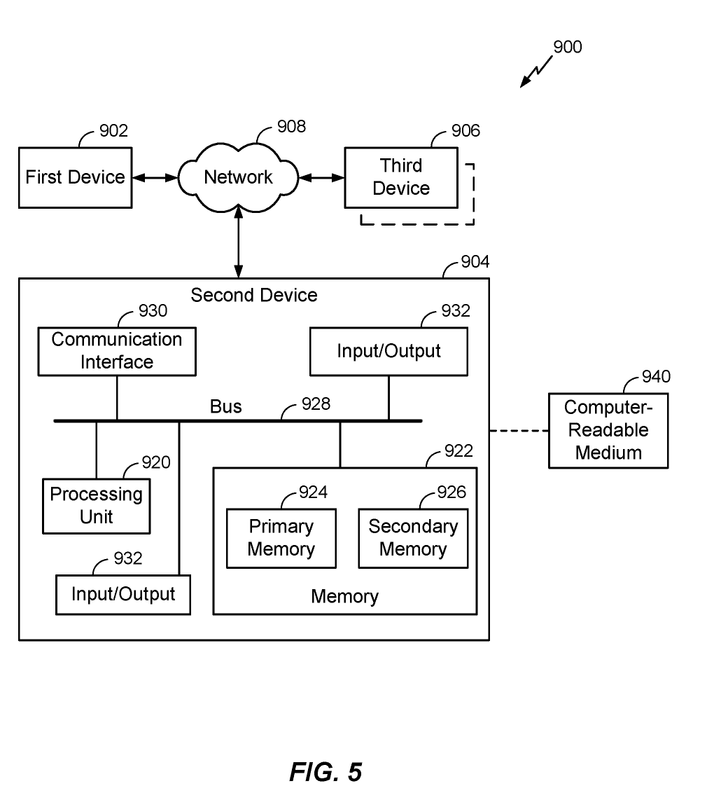

Subject matter shown in FIGS. 4 and 5 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure within the meaning of 35 USC § 112(f) so that it is specifically intended that 35 USC § 112(f) not be implicated by use of the term “computing device,” “wireless station,” “wireless transceiver device” and/or similar terms; however, if it is determined, for some reason not immediately apparent, that the foregoing understanding cannot stand and that 35 USC § 112(f) therefore, necessarily is implicated by the use of the term “computing device,” “wireless station,” “wireless transceiver device” and/or similar terms, then, it is intended, pursuant to that statutory section, that corresponding structure, material and/or acts for performing one or more functions be understood and be interpreted to be described at least in FIG. 2, and corresponding text of the present disclosure.

FIG. 4 is a schematic diagram of a mobile device 800 according to an embodiment. Mobile device 100 (including mobile devices 100ₐ and 100_{b}) as shown in FIGS. 1 and 3 may comprise one or more features of mobile device 800 shown in FIG. 4. In certain embodiments, mobile device 800 may comprise a wireless transceiver 821 which is capable of transmitting and receiving wireless signals 823 via wireless antenna 822 over a wireless communication network. Wireless transceiver 821 may be connected to bus 801 by a wireless transceiver bus interface 820. Wireless transceiver bus interface 820 may, in some embodiments be at least partially integrated with wireless transceiver 821. Some embodiments may include multiple wireless transceivers 821 and wireless antennas 822 to enable transmitting and/or receiving signals according to corresponding multiple wireless communication standards such as, for example, versions of IEEE Standard 802.11, CDMA, WCDMA, LTE, UMTS, GSM, AMPS, Zigbee, Bluetooth and a 5G or NR radio interface defined by 3GPP, just to name a few examples. In a particular implementation, wireless transceiver 821 may be used to observe signals transmitted by an access device to, for example, compute an estimated error in a frequency of an oscillating signal generated for advancing a clock state as set forth in expression (1).

Mobile device 800 may also comprise SPS receiver 855 capable of receiving and acquiring SPS signals 859 via SPS antenna 858 (which may be the same as antenna 822 in some embodiments). SPS receiver 855 may also process, in whole or in part, acquired SPS signals 859 for estimating a location of mobile device 800. SPS receiver 855 may observe an SPS time from acquired SPS signals 859 to, for example, compute an estimate error in frequency of an oscillating signal according to expression (1), an estimated SPS time at a particular future instance according to expression (2) or compute an uncertainty in an estimated SPS time according to expression (3). In some embodiments, general-purpose processor(s) 811, memory 840, digital signal processor(s) (DSP(s)) 812 and/or specialized processors (not shown) may also be utilized to process acquired SPS signals, in whole or in part, and/or calculate an estimated location of mobile device 800, in conjunction with SPS receiver 855. Storage of SPS, TPS or other signals (e.g., signals acquired from wireless transceiver 821) or storage of measurements of these signals for use in performing positioning operations may be performed in memory 840 or registers (not shown). General-purpose processor(s) 811, memory 840, DSP(s) 812 and/or specialized processors may provide or support a location engine for use in processing measurements to estimate a location of mobile device 800. In a particular implementation, all or portions of actions or operations set forth for process 200 may be executed by general-purpose processor(s) 811 or DSP(s) 812 based on machine-readable instructions stored in memory 840. For example general-purpose processor(s) 811 or DSP(s) 812 may process a downlink signal acquired by wireless transceiver 821 to, for example, determine timing advance parameters and an estimated location as described above.

Clock circuit 838 may comprise circuitry for maintaining a clock state representative of or tracking a system time (e.g., SPS time). In an example implementation, clock circuit 838 may comprise a local oscillator (e.g., crystal oscillator, not shown) to advance a clock state according to an oscillating frequency. In an embodiment, a clock state maintained at clock circuit 838 may be used to estimate an SPS time at a particular instance for determining a window to search for and/or acquire an SPS signal as discussed above.

Also shown in FIG. 4, digital signal processor(s) (DSP(s)) 812 and general-purpose processor(s) 811 may be connected to memory 840 through bus 801. A particular bus interface (not shown) may be integrated with the DSP(s) 812, general-purpose processor(s) 811 and memory 840. In various embodiments, functions may be performed in response to execution of one or more machine-readable instructions stored in memory 840 such as on a computer-readable storage medium, such as RAM, ROM, FLASH, or disc drive, just to name a few example. The one or more instructions may be executable by general-purpose processor(s) 811, specialized processors, or DSP(s) 812. Memory 840 may comprise a non-transitory processor-readable memory and/or a computer-readable memory that stores software code (programming code, instructions, etc.) that are executable by processor(s) 811 and/or DSP(s) 812 to perform functions or actions described above in connection with FIG. 200.

Also shown in FIG. 4, a user interface 835 may comprise any one of several devices such as, for example, a speaker, microphone, display device, vibration device, keyboard, touch screen, just to name a few examples. In a particular implementation, user interface 835 may enable a user to interact with one or more applications hosted on mobile device 800. For example, devices of user interface 835 may store analog or digital signals on memory 840 to be further processed by DSP(s) 812 or general purpose processor 811 in response to action from a user. Similarly, applications hosted on mobile device 800 may store analog or digital signals on memory 840 to present an output signal to a user. In another implementation, mobile device 800 may optionally include a dedicated audio input/output (I/O) device 870 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 800 may comprise touch sensors 862 responsive to touching or pressure on a keyboard or touch screen device.

Mobile device 800 may also comprise a dedicated camera device 864 for capturing still or moving imagery. Camera device 864 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 811 or DSP(s) 812. Alternatively, a dedicated video processor 868 may perform conditioning, encoding, compression or manipulation of signals representing captured images. Additionally, video processor 868 may decode/decompress stored image data for presentation on a display device (not shown) on mobile device 800.

Mobile device 800 may also comprise sensors 860 coupled to bus 801 which may include, for example, inertial sensors and environment sensors. Inertial sensors of sensors 860 may comprise, for example accelerometers (e.g., collectively responding to acceleration of mobile device 800 in three dimensions), one or more gyroscopes or one or more magnetometers (e.g., to support one or more compass applications). Environment sensors of mobile device 800 may comprise, for example, temperature sensors, barometric pressure sensors, ambient light sensors, camera imagers, microphones, just to name few examples. Sensors 860 may generate analog or digital signals that may be stored in memory 840 and processed by DPS(s) 812 or general purpose application processor 811 in support of one or more applications such as, for example, applications directed to positioning or navigation operations.

In a particular implementation, mobile device 800 may comprise a dedicated modem processor 866 capable of performing baseband processing of signals received and downconverted at wireless transceiver 821 or SPS receiver 855. Similarly, modem processor 866 may perform baseband processing of signals to be upconverted for transmission by wireless transceiver 821. In alternative implementations, instead of having a dedicated modem processor, baseband processing may be performed by a general purpose processor or DSP (e.g., general purpose/application processor 811 or DSP(s) 812). It should be understood, however, that these are merely examples of structures that may perform baseband processing, and that claimed subject matter is not limited in this respect.

FIG. 5 is a schematic diagram illustrating an example system 900 that may include one or more devices configurable to implement techniques or processes described above. System 900 may include, for example, a first device 902, a second device 904, and a third device 906, which may be operatively coupled together through a wireless communications network 908. In an aspect, second device 904 may comprise a server or location server, such as servers 140, 150 or 155. Also, in an aspect, wireless communications network 908 may comprise one or more wireless access points, for example. However, claimed subject matter is not limited in scope in these respects.

First device 902, second device 904 and third device 906 may be representative of any device, appliance or machine. By way of example but not limitation, any of first device 902, second device 904, or third device 906 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 902, 904, and 906, respectively, may comprise one or more of a location server, a base station almanac server, a location server function, a base station, or a mobile device in accordance with the examples described herein.

Similarly, wireless communications network 908, may be representative of one or more communication links, processes, or resources configurable to support the exchange of data between at least two of first device 902, second device 904, and third device 906. By way of example but not limitation, wireless communications network 908 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured by third device 906, there may be additional like devices operatively coupled to wireless communications network 908.

It is recognized that all or part of the various devices and networks shown in system 900, and the processes and methods as further described herein, may be implemented using or otherwise including hardware, firmware, software, or any combination thereof.

Thus, by way of example but not limitation, second device 904 may include at least one processing unit 920 that is operatively coupled to a memory 922 through a bus 928.

Processing unit 920 is representative of one or more circuits configurable to perform at least a portion of a data computing procedure or process. By way of example but not limitation, processing unit 920 may include one or more processors, controllers, microprocessors, microcontrollers, application specific integrated circuits, digital signal processors, programmable logic devices, field programmable gate arrays, and the like, or any combination thereof.

Memory 922 is representative of any data storage mechanism. Memory 922 may include, for example, a primary memory 924 or a secondary memory 926. Primary memory 924 may include, for example, a random access memory, read only memory, etc. While illustrated in this example as being separate from processing unit 920, it should be understood that all or part of primary memory 924 may be provided within or otherwise co-located/coupled with processing unit 920.

Secondary memory 926 may include, for example, the same or similar type of memory as primary memory or one or more data storage devices or systems, such as, for example, a disk drive, an optical disc drive, a tape drive, a solid state memory drive, etc. In certain implementations, secondary memory 926 may be operatively receptive of, or otherwise configurable to couple to, a computer-readable medium 940. Computer-readable medium 940 may include, for example, any non-transitory medium that can carry or make accessible data, code or instructions for one or more of the devices in system 900. Computer-readable medium 940 may also be referred to as a storage medium. For example, computer-readable medium 940 may store computer readable instructions to, at least in part, perform actions or operations shown in FIG. 2, or computations such as computations to estimate an error in a frequency of an oscillating signal according to expression (1).

Second device 904 may include, for example, a communication interface 930 that provides for or otherwise supports the operative coupling of second device 904 to at least wireless communications network 908. By way of example but not limitation, communication interface 930 may include a network interface device or card, a modem, a router, a switch, a transceiver, and the like.

Second device 904 may include, for example, an input/output device 932. Input/output device 932 is representative of one or more devices or features that may be configurable to accept or otherwise introduce human or machine inputs, or one or more devices or features that may be configurable to deliver or otherwise provide for human or machine outputs. By way of example but not limitation, input/output device 932 may include an operatively configured display, speaker, keyboard, mouse, trackball, touch screen, data port, etc.

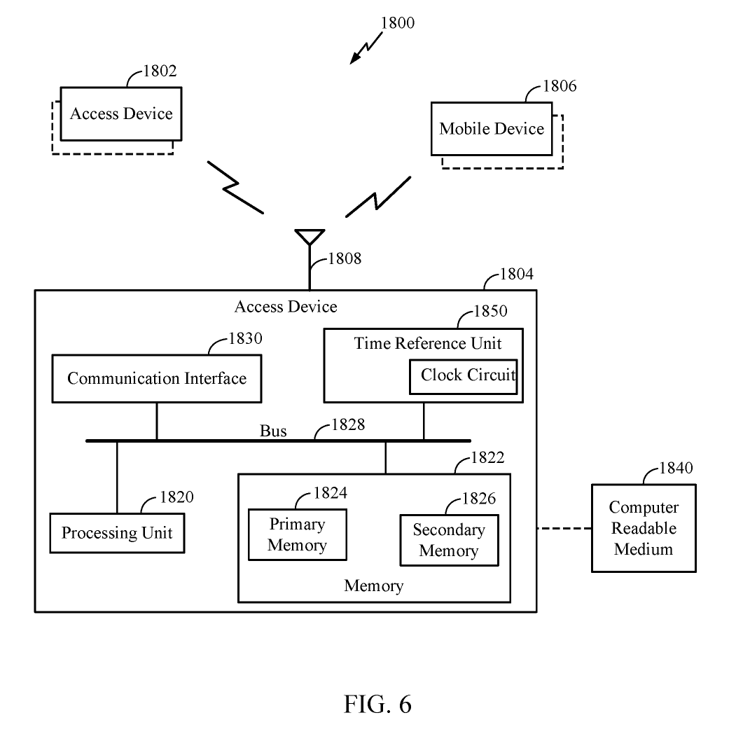

FIG. 6 is a schematic diagram illustrating an example system 1800 that may include one or more devices configurable to implement techniques or processes described above, for example, in connection with FIGS. 1 and 3. System 1800 may include, for example, a first device 1802, a second device 1804, and a third device 1806, which may be operatively coupled together through a wireless communications network. In an aspect, first device 1802 may comprise an access point as shown, for example. Second device 1804 may comprise an access device (e.g., local transceiver 115 or base station transceiver 110) and third device 1806 may comprise a mobile station or mobile device, in an aspect. Also, in an aspect, devices 1802, 1804 and 1802 may be included in a wireless communications network may comprise one or more wireless access points, for example. However, claimed subject matter is not limited in scope in these respects.

First device 1802, second device 1804 and third device 1806, as shown in FIG. 6, may be representative of any device, appliance or machine that may be configurable to exchange data over a wireless communications network. By way of example but not limitation, any of first device 1802, second device 1804, or third device 1806 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1802, 1804, and 1806, respectively, may comprise one or more of an access point or a mobile device in accordance with the examples described herein.

Similarly, a wireless communications network, as shown in FIG. 6, is representative of one or more communication links, processes, or resources configurable to support the exchange of data between at least two of first device 1802, second device 1804, and third device 1806. By way of example but not limitation, a wireless communications network may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1806, there may be additional like devices operatively coupled to wireless communications network 1808.

It is recognized that all or part of the various devices and networks shown in FIG. 6, and the processes and methods as further described herein, may be implemented using or otherwise including hardware, firmware, software, or any combination thereof.

Thus, by way of example but not limitation, second device 1804 may include at least one processing unit 1820 that is operatively coupled to a memory 1822 through a bus 1828.

Processing unit 1820 is representative of one or more circuits configurable to perform at least a portion of a data computing procedure or process. By way of example but not limitation, processing unit 1820 may include one or more processors, controllers, microprocessors, microcontrollers, application specific integrated circuits, digital signal processors, programmable logic devices, field programmable gate arrays, and the like, or any combination thereof.

Memory 1822 is representative of any data storage mechanism. Memory 1822 may include, for example, a primary memory 1824 or a secondary memory 1826. Primary memory 1824 may include, for example, a random access memory, read only memory, etc. While illustrated in this example as being separate from processing unit 1820, it should be understood that all or part of primary memory 1824 may be provided within or otherwise co-located/coupled with processing unit 1820.

Secondary memory 1826 may include, for example, the same or similar type of memory as primary memory or one or more data storage devices or systems, such as, for example, a disk drive, an optical disc drive, a tape drive, a solid state memory drive, etc. In certain implementations, secondary memory 1826 may be operatively receptive of, or otherwise configurable to couple to, a computer-readable medium 1840. Computer-readable medium 1840 may include, for example, any non-transitory medium that can carry or make accessible data, code or instructions for one or more of the devices in system 1800. Computer-readable medium 1840 may also be referred to as a storage medium.

Second device 1804 may include, for example, a communication interface 1830 that provides for or otherwise supports the operative coupling of second device 1804 to a wireless communications network at least through an antenna 1808. By way of example but not limitation, communication interface 1830 may include a network interface device or card, a modem, a router, a switch, a transceiver, and the like. In other alternative implementations, communication interface 1830 may comprise a wired/LAN interface, wireless LAN interface (e.g., IEEE std. 802.11 wireless interface) and/or a wide area network (WAN) air interface.

Second device 1804 may include, for example, an input/output device 1832. Input/output device 1832 is representative of one or more devices or features that may be configurable to accept or otherwise introduce human or machine inputs, or one or more devices or features that may be configurable to deliver or otherwise provide for human or machine outputs. By way of example but not limitation, input/output device 1832 may include an operatively configured display, speaker, keyboard, mouse, trackball, touch screen, data port, etc. Clock reference unit 1850 may comprise a clock circuit to maintain a clock state representative of a system time. The clock circuit may comprise, for example, a local oscillator (e.g., a crystal oscillator) to generating an oscillating signal for advancing the clock state. The clock state may be used, for example, to generate time references in symbols encoded in signals transmitted by second device 1804 which may enable mobile device 1806 to observe a system time as maintained by second device 1804 as discussed above.

As used herein, the terms “mobile device” and “user equipment” (UE) are used synonymously to refer to a device that may from time to time have a location that changes. The changes in location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband CDMA (WCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and WCDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. 4G Long Term Evolution (LTE) and 5G or New Radio (NR) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (CDMA) cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method at a mobile device comprising:
acquiring satellite positioning system (SPS) signals at multiple instances over a first duration while the mobile device is camped on one or more signals transmitted by a first access device;
determining one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and
determining a second duration of time to acquire a subsequent SPS signal based, at least in part, on the one or more parameters indicative of the error in the clock signal maintained at the mobile device.

2. The method of claim 1, wherein the one or more parameters indicative of the error in the clock signal is determined based, at least in part, on a first frequency error in a first oscillating signal maintained at the first access device based, at least in part, on the acquired SPS signals and the representations of system time in the signals received from the first access device contemporaneously with acquisition of the SPS signals.

3. The method of claim 1, wherein the one or more parameters indicative of the error in the clock signal is based, at least in part, on a second frequency error in a second oscillating signal maintained at the mobile device, the second frequency error in the second oscillating signal being determined based, at least in part, on the first frequency error in the first oscillating signal.

4. The method of claim 1, wherein the access device comprises an eNode B device, a WLAN access point or a femto cell, or a combination thereof.

5. The method of claim 1, wherein the second duration of time to acquire the subsequent SPS signal is performed while the mobile device is subsequently camped on the access device.

6. The method of claim 1, wherein the one or more parameters indicative of the error in the clock signal is further based, at least in part, on crowdsourced observations of signals transmitted by the first access device obtained by other mobile devices.

7. The method of claim 1, and further comprising:
camping on signals transmitted by the first access device and a second access device;
determining a first estimate of error in frequency of a first oscillating signal generated by the first access device and a second estimate of error in frequency of a second oscillating signal generated by the second access device;
selecting a first representation of time based on signals transmitted by the first access device or a second representation of time based on signals transmitted by the second access device for determination of the second duration based, at least in part, on a comparison of the first estimate of error in frequency of the first oscillating signal and the second estimate of error in frequency of the second oscillating signal; and
determining the second duration of time based, at least in part, on the selected representation of time.

8. The method of claim 1, and further comprising determining the indication of stationarity of the mobile device based, at least in part, on one or more signals generated by one or more inertial sensors of the mobile device.

9. The method of claim 1, and further comprising determining the indication of stationarity of the mobile device based, at least in part, on a detected change in at least one ambient received radio frequency (RF) signals.

10. The method of claim 1, and further comprising:
updating an estimated rate in growth of the error in the clock signal maintained at the mobile device is further based, at least in part, on the one or more parameters indicative of the error in the clock signal;
propagating an estimate of the error in the clock signal at an instance in time based, at least in part, on the updated estimated rate in growth of the error in the clock signal; and
determining a third duration of time to acquire a second subsequent SPS signal at the instance in time based, at least in part, on the propagated estimate of the error in the clock signal.

11. A mobile device comprising:
a first receiver to process satellite positioning system (SPS) signals;
a second receiver to process signals transmitted in a communication network; and
one or more processors to:
acquire SPS signals received at the first receiver at multiple instances over a first duration while the second receiver is camped on one or more signals transmitted by a first access device;
determine one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and
determine a second duration of time to acquire a subsequent SPS signal received at the second receiver based, at least in part, on the one or more parameters indicative of the error in the clock signal maintained at the mobile device.

12. The mobile device of claim 11, wherein the one or more parameters indicative of the error in the clock signal is determined based, at least in part, on a first frequency error in a first oscillating signal maintained at the first access device based, at least in part, on the acquired SPS signals and the representations of system time in the signals received from the first access device contemporaneously with acquisition of the SPS signals.

13. The mobile device of claim 11, wherein the one or more parameters indicative of the error in the clock signal is based, at least in part, on a second frequency error in a second oscillating signal maintained at the mobile device, the second frequency error in the second oscillating signal being determined based, at least in part, on the first frequency error in the first oscillating signal.

14. The mobile device of claim 11, wherein the access device comprises an eNode B device, a WLAN access point or a femto cell, or a combination thereof.

15. The mobile device of claim 11, wherein the second duration of time to acquire the subsequent SPS signal is performed while the mobile device is subsequently camped on the access device.

16. The mobile device of claim 11, wherein the one or more parameters indicative of the error in the clock signal is further based, at least in part, on crowdsourced observations of signals transmitted by the first access device obtained by other mobile devices.

17. The mobile device of claim 11, wherein the one or more processors are further configured to:
camp on signals received at the second receiver and transmitted by the first access device and a second access device;
determine a first estimate of error in frequency of a first oscillating signal generated by the first access device and a second estimate of error in frequency of a second oscillating signal generated by the second access device;
select a first representation of time based on signals transmitted by the first access device or a second representation of time based on signals transmitted by the second access device for determination of the second duration based, at least in part, on a comparison of the first estimate of error in frequency of the first oscillating signal and the second estimate of error in frequency of the second oscillating signal; and
determine the second duration of time based, at least in part, on the selected representation of time.

18. The mobile device of claim 11, and wherein the one or more processors are further configured to determine the indication of stationarity of the mobile device based, at least in part, on one or more signals generated by one or more inertial sensors of the mobile device.

19. The mobile device of claim 11, and wherein the one or more processors are further configured to determine the indication of stationarity of the mobile device based, at least in part, on a detected change in at least one ambient received radio frequency (RF) signals.

20. The mobile device of claim 11, wherein the one or more processors are further configured to:
update an estimated rate in growth of the error in the clock signal maintained at the mobile device is further based, at least in part, on the one or more parameters indicative of the error in the clock signal;
propagate an estimate of the error in the clock signal at an instance in time based, at least in part, on the updated estimated rate in growth of the error in the clock signal; and
determine a third duration of time to acquire a second subsequent SPS signal at the instance in time based, at least in part, on the propagated estimate of the error in the clock signal.

21. A storage medium comprising computer readable instructions stored thereon which are executable by one or more processors of a mobile device to:
acquire satellite positioning system (SPS) signals received at the mobile device at multiple instances over a first duration while the mobile device is camped on one or more signals transmitted by a first access device;
determine one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and
determine a second duration of time to acquire a subsequent SPS signal based, at least in part, on the one or more parameters indicative of the error in the clock signal maintained at the mobile device.

22. The storage medium of claim 21, wherein the one or more parameters indicative of the error in the clock signal is determined based, at least in part, on a first frequency error in a first oscillating signal maintained at the first access device based, at least in part, on the acquired SPS signals and the representations of system time in the signals received from the first access device contemporaneously with acquisition of the SPS signals.

23. The storage medium of claim 21, wherein the second duration of time to acquire the subsequent SPS signal is performed while the mobile device is subsequently camped on the access device.

24. The storage medium of claim 21, and further comprising determining the indication of stationarity of the mobile device based, at least in part, on one or more signals generated by one or more inertial sensors of the mobile device.

25. The storage medium of claim 21, wherein the instructions are further executable by the one or more processors to:
update an estimated rate in growth of the error in the clock signal maintained at the mobile device is further based, at least in part, on the one or more parameters indicative of the error in the clock signal;
propagate an estimate of the error in the clock signal at an instance in time based, at least in part, on the updated estimated rate in growth of the error in the clock signal; and
determine a third duration of time to acquire a second subsequent SPS signal at the instance in time based, at least in part, on the propagated estimate of the error in the clock signal.

26. A mobile device comprising:
means for acquiring satellite positioning system (SPS) signals at multiple instances over a first duration while the mobile device is camped on one or more signals transmitted by a first access device;
means for determining one or more parameters indicative of an error in a clock signal maintained at the mobile device based, at least in part, on the acquired SPS signals, representations of system time in signals received from the first access device contemporaneously with acquisition of the SPS signals and an indication of stationarity of the mobile device during the first duration; and
means for determining a second duration of time to acquire a subsequent SPS signal based, at least in part, on the one or more parameters indicative of the error in the clock signal maintained at the mobile device.

27. The mobile device of claim 26, wherein the one or more parameters indicative of the error in the clock signal is determined based, at least in part, on a first frequency error in a first oscillating signal maintained at the first access device based, at least in part, on the acquired SPS signals and the representations of system time in the signals received from the first access device contemporaneously with acquisition of the SPS signals.

28. The mobile device of claim 26, wherein the second duration of time to acquire the subsequent SPS signal is performed while the mobile device is subsequently camped on the access device.

29. The mobile device of claim 26, and further comprising:
means for camping on signals transmitted by the first access device and a second access device;
means for determining a first estimate of error in frequency of a first oscillating signal generated by the first access device and a second estimate of error in frequency of a second oscillating signal generated by the second access device;
means for selecting a first representation of time based on signals transmitted by the first access device or a second representation of time based on signals transmitted by the second access device for determination of the second duration based, at least in part, on a comparison of the first estimate of error in frequency of the first oscillating signal and the second estimate of error in frequency of the second oscillating signal; and
means for determining the second duration of time based, at least in part, on the selected representation of time.

30. The mobile device of claim 26, and further comprising means for determining the indication of stationarity of the mobile device based, at least in part, on one or more signals generated by one or more inertial sensors of the mobile device.
